(19) United States
(12) Patent Application Publication
(10) Pub. No.: US 2003/0106025 A1
(43) Pub. Date: Jun. 5, 2003

(54) Method and system for providing XML-based web pages for non-pc information terminals

(76) Inventors: Soo Sun Cho, Taejon (KR); Dong Woo Lee, Taejon (KR); Hee Sook Shin, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/015,754

(22) Filed: Dec. 17, 2001

(30) Foreign Application Priority Data
Nov. 20, 2001 (KR) 2001 - 72225

(51) Int. Cl. G09G 5/00

(52) U.S. Cl. 715/523

(57) ABSTRACT

A method and system for providing XML-based web pages for non-PC information terminals are disclosed. The system comprises an HTML-XML reconstruction for transforming an HTML document transmitted from the web server to generate XML and XSL documents in a pattern of data adapted to the web client of the non-PC information terminal, an image reformat for reformatting an image in the web page in a pattern of data adapted to the web client of the non-PC information terminal corresponding to the XML and XSL documents generated by the HTML-XML reconstruction, a pre-fetch for pre-fetching the web page received from the web server according to a probability condition based on a reference history of the web client, a store for storing the pre-fetched web page, and the XML and XSL documents, and an HTTP for connecting to the web client of the non-PC information terminal and the web server by use of an HTTP protocol to transfer the web page transmitted from the web server to the HTML-XML reconstruction, and providing the information stored in the store to the web client of the non-PC information terminal.

### BACKGROUND OF THE INVENTION

1. Field of the Invention

The present invention relates to a method and system for providing XML-based web pages for non-PC information terminals, and more particularly, to a method and system for providing XML-based web pages for non-PC information terminals in a proxy server for effectively obtaining and displaying the web page on the non-PC information terminals.

2. Background of the Related Art

Internet is a worldwide interconnection of computer networks that communicate using a common protocol. The World-Wide-Web was introduced early in 1990, and comprises a server hosting computer (web server) connected to the Internet, in which hypertext documents are stored.

Web pages stored in the web server may be accessed by a client program (for example, web browser) using a hypertext transfer protocol (HTTP) via the Transmission Control Protocol/Internet Protocol (TCP/IP) connection between a client hosting device (web client) and the server hosting computer.

The web page is generally formatted in a standard page technical language, such as a Hypertext Markup Language (HTML), and typically comprises a text. Also, the web page may be referred to image, sound, animation, and video data.

Accordingly, the HTML document is designated to a portion of the web page. General web page comprises graphic image files, as well as HTML documents. When a user selects a specific hypertext link, the web browser reads and translates an address connected to the link, called as a Uniform Resource Locator (URL), and connects to the web server of the corresponding address to request identified files in the link. And next, the web server provides the request file to the web client, and the web browser translates the request file to display it to the user.

The importance of the Internet has been increased in the present age of information, and in particular the acquisition of information via the web becomes an indispensable element of life. In particular, according to the sudden increase of utilizing the web by use of web-TV, PDA, web-phone or the like, as well as typical desktop computers, attempts for supporting more smooth web browsing in the computing unit are increased.

Such non-PC information terminals have a display of a small size relative to the desktop computer, and also are limited to a processor, a memory capacity, and a communication speed. Accordingly, if most of existing web pages prepared for the personal computer are not properly downsized, transmission and display cannot be performed in real time.

Because of such a necessity, patents related to the web page transformation are gradually increased. Korean Paten Application No. 10-1999-0043778, entitled ‘method for transforming documents using next-generation standard Markup Language’, discloses a method comprising the steps of: collecting the web pages; transforming the web pages to XML documents; and transforming the XML documents to different type of texts and transferring them. Even though the application discloses a technique for collecting and caching the web documents, and after transforming it to the XML document, again transforming the XML document to different type of text only, concrete means for achieving the object is not disclosed therein.

Therefore, HTML to XML transformation for the conceptual and physical downsizing proposed by the present invention is different from the above application.

Although Korean Patent Application No. 10-2000-0003971, entitled ‘method, system and computer program for reconstructing contents of web page’, discloses the transformation of the HTML format to XML format having characteristics of discriminating between a portion transformed to the XML format and untransformed masking portion, and integrating and displaying a masking released portion together with the inversely transformed XML format, the method for transforming the XML format is not disclosed. Because no a method for transforming the XML regarding to non-PC information terminals is provided in the prior art, there is a drawback when the web pages of the web server is serviced in the non-PC information terminals.

### SUMMARY OF THE INVENTION

Accordingly, the present invention is directed to a method and system for providing XML-based web pages for non-PC information terminals that substantially obviates one or more problems due to limitations and disadvantages of the related art.

An object of the present invention is to provide a method and system for providing XML-based web pages for non-PC information terminals, on the bases of the meaningful element extraction every searching domain and the style element generation depending upon terminal condition, so that the XML documents can be properly reconstructed depending upon the kinds of searching domains and information terminals.

To achieve the object and other advantages, according to one aspect of the present invention, there is provided a system of providing an XML-based web page of a proxy server providing a home page of a web server for a web client of a non-PC information terminal, the system comprising: an HTML-XML reconstruction for transforming an HTML document transferred from the web server to generate XML and XSL documents in a pattern of data adapted to the web client of the non-PC information terminal; an image reformat for reformatting an image in the web page in a pattern of data adapted to the web client of the non-PC information terminal corresponding to the XML and XSL documents generated by the HTML-XML reconstruction; a pre-fetch for pre-fetching the web page received from the web server according to a probability condition based on a reference history of the web client; a store for storing the pre-fetched web page, and the XML and XSL documents; and an HTTP for connecting to the web client of the non-PC information terminal and the web server by use of an HTTP protocol to transfer the web page transmitted from the web server to the HTML-XML reconstruction, and providing the information stored in the store to the web client of the non-PC information terminal.

According to another aspect of the present invention, there is provided a method of providing an XML-based web page of a proxy server providing a home page of a web server for a web client of a non-PC information terminal, the method comprising the steps of: transforming an HTML document transferred from the web server to generate an XML document adapted to a domain containing a content of the web page and an XSL document adapted to a device of the web client; reformatting an image in the web page in a pattern of data adapted to the web client of the non-PC information terminal corresponding to the XML and XSL documents generated; pre-fetching for the web page received from the web server according to a probability condition based on a reference history of the web client, and temporarily storing the pre-fetched web page; and upon receiving a request of the web client of the non-PC information terminal, providing the XML and XSL documents, the image, and the web page to the web client of the non-PC information terminal.

According to still another aspect of the present invention, there is provided a storage medium for executing a method of providing an XML-based web page of a proxy server providing a home page of a web server for a web client of a non-PC information terminal, the storage medium capable of being read by a digital processor, and storing a program of commands executed by the digital processor, the program being implemented by types, with the program comprising the steps of: transforming an HTML document transferred from the web server to generate an XML document adapted to a domain containing a content of the web page and an XSL document adapted to a device of the web client; reformatting an image in the web page in a pattern of data adapted to the web client of the non-PC information terminal corresponding to the XML and XSL documents generated; pre-fetching for the web page received from the web server according to a probability condition based on a reference history of the web client, and temporarily storing the pre-fetched web page; and upon receiving a request of the web client of the non-PC information terminal, providing the XML and XSL documents, the image, and the web page to the web client of the non-PC information terminal.

According to teachings of the present invention, domain-adapted DTD is selected by use of a DTD database reflected the previously constructed domain characteristic, and the meaningful elements represented by the domain-adapted DTD are extracted from the HTML document transmitted from the web server, thereby generating a domain-adapted XML document. Further, the present invention generates a style information by use of information terminal device information transferred via the web browser, thereby generating a device-adapted XSL document. The conceptual downsizing of the web page can be performed through the generation of the domain-adapted XML document, and the physical downsizing of the web page can be performed through the generation of the device-adapted XSL document.

The present invention provides a solution at the transformation from the HTML document to the XML document, so that so that a great amount of the existing web pages for PC may be automatically transformed and reused to non-PC web pages.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a network environment for carrying out a web service using non-PC information terminals according to the present invention;

FIG. 2 is a diagram illustrating the construction of the proxy server according to the present invention;

FIG. 3 is a diagram illustrating the construction of the HTML-XML reconstruction in FIG. 2;

FIG. 4 shows one embodiment of the domain-adapted DTD selected from the domain-specific DTD database by the domain selection of FIG. 3;

FIG. 5 is an exemplary view illustrating a domain-adapted XML document generated by use of a tour destination DTD of FIG. 4; and

FIG. 6 is an exemplary view illustrating a device-adapted XML document generated by use of a tour destination DTD of FIG. 4

### DETAILED DESCRIPTION OF THE PREFERRED EMBODIMENTS

Reference will now be made in detail to the preferred embodiment of the present invention, examples of which are illustrated in the accompanying drawings.

The XML which is a major principle of the present invention will now be explained.

The XML is a formal language capable of making the web as a tool providing more various functions, and its standard is published by the WORLD WIDE WEB Associations. XML and HTML are a language subset of the Standard Generalized Markup Language (SGML), and are similar to each other from the standpoint of using a tag for describing the contents of page or file.

The HTML describes the contents of the web page (mainly, text and graphic image) in view of how the contents are displayed and cooperates with each other, while the XML describes the contents themselves in view of which the text is described. In the HTML, the style information of the document indicative of how the contents are displayed is defined by the separate Extensible Stylesheet Language (XSL). The XSL style information is transformed to HTML or other format together with XML content information.

Meanwhile, Document Type Definition (DTD) is accompanied with the XML document, and defines a rule of the XML document, in other words, what kinds of elements exist and how the structural relationship of the elements is.

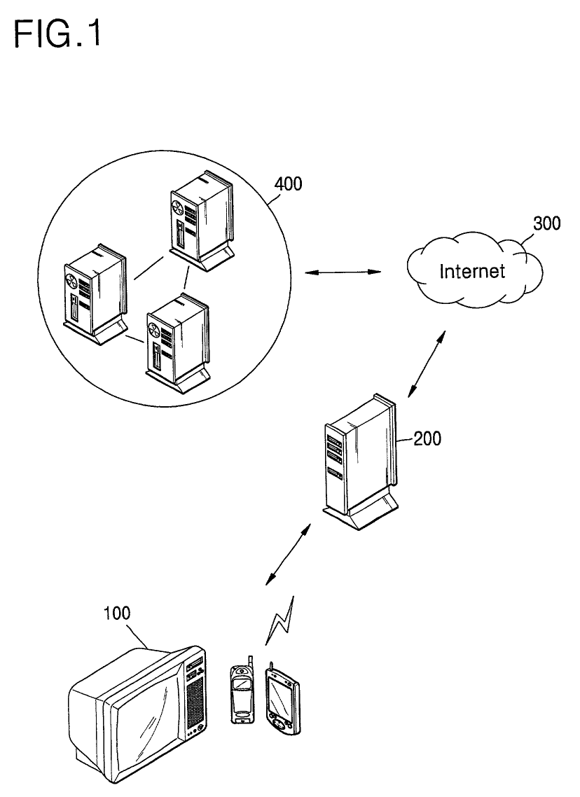

FIG. 1 is a schematic view illustrating a network environment for carrying out a web service using non-PC information terminals according to the present invention, in which the web service comprises a web client 100, a proxy server 200, an Internet network 300, and a web server 400.

The web client 100 will be classified into wire information terminals and wireless information terminals. The wire information terminal is a non-PC information terminal device, such as web-TV, capable of receiving and displaying a web page from the web server 400 via a cable, while the wireless information terminal is a non-PC information terminal device, such as PDA and web phone, capable of receiving and displaying the web page from the web server 400 via a wireless network.

The proxy server 200 performs the transformation of the web page corresponding to features of each terminal, when serving as a function of providing a web image of the web server 400 to the web client 100 upon receiving a request of the web client 100. Herein, the web page generally refers to HTML documents and various kinds of image files in the web page.

The web server 400 serves as a function of providing each web page by use of HTTP protocol upon receiving a request of the proxy server 200 via the Internet network 300.

It will be explained on the function of achieving a service for the non-PC information terminal in the proxy server 200 of the network system according to the present invention.

Upon receiving a request of certain web page from the web client 100, the proxy server 200 determines whether the requested web page is stored. If it is stored, the proxy server provides the stored web page to the web client 100. Meanwhile, if the web page requested from the web client 100 is not stored, the proxy server connects to the web server to obtain the corresponding web page, and downsizes the web page to be adapted to the terminal feature of the web client 100, in order to transform it to a web page capable of being displayed on the web client 100. The transformed web page is provided to the web client 100.

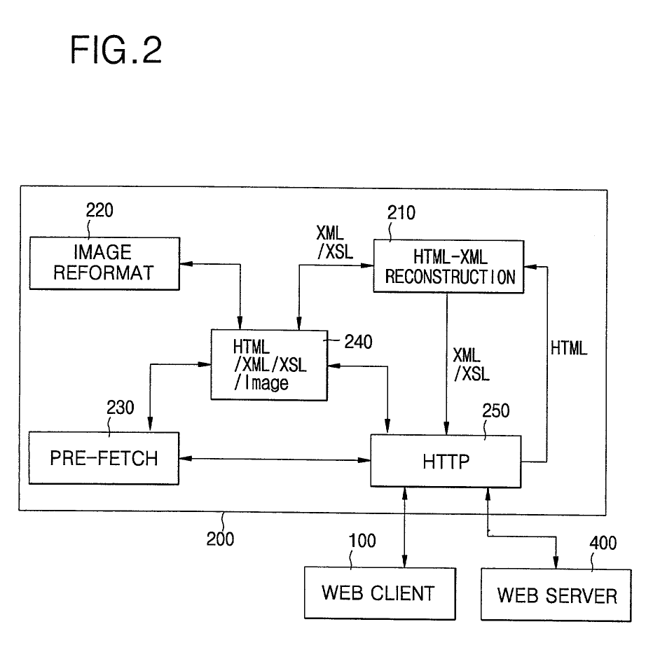

FIG. 2 is a diagram illustrating the construction of the proxy server according to the present invention. The construction and operation of the proxy server will now be explained with reference to FIG. 2.

Referring to FIG. 2, the proxy server 200 comprises an HTML-XML reconstruction 210 for transforming an HTML document transmitted from the web server to generate XML and XSL documents in a pattern of data adapted to the web client 100 of the non-PC information terminal, an image reformat 220 for reformatting the images in the web page in a pattern of data adapted to the web client 100 of the non-PC information terminal corresponding to the XML and XSL documents generated by the HTML-XML reconstruction 210, a pre-fetch 230 for pre-fetching the web page transmitted from the web server 400, a store 240 for storing the pre-fetched web page, and the XML and XSL documents, and an HTTP 250 for connecting to the web client of the non-PC information terminal and the web server by use of the HTTP protocol to transfer the web page received from the web server 400 to the HTML-XML reconstruction 210, and providing the web page, which is stored in the store 240 in a pattern of data adapted to the web client 100 of the no-PC information terminal, to the web client 100 of the no-PC information terminal.

The HTML-XML reconstruction 210 generates a domain-adapted XML document based on the HTML document received from the HTTP 250, and generates a device-adapted document for style information.

The image reformat 220 controls dimensions of the image, and transforms the format of the image, depending upon the display conditions of the web client 100. Specifically, resolution is controlled to be adapted to the size of various kinds of information terminal display such as 320*200, 640*480 or the like, and the format of the image such as bit map, GIF, JPEG or the like is transformed depending upon the decoding ability of the web client.

At that time, the condition of the image reformat is obtained from the device-adapted XSL document which is a print result of the HTML-XML reconstruction 210.

When the HTTP 250 receives the web page form the web server 400, the pre-fetch 230 pre-fetches the corresponding page depending upon the conditions, and stores the result in the store 240. At that time, the general condition of the pre-fetch is a case that the probability of which the corresponding web page is accessed in the near future is higher than a reference value, the probability being calculated based on a reference history of the web client.

The store 240 stores the domain-adapted XML document and the device-adapted XSL document, generated from the HTML-XML reconstruction 210, the image generated from the image reformat 220, and the web page pre-fetched by the pre-fetch 230.

The HTTP 250 provides the HTTP protocol connecting function performed by the typical web server 400 to corresponding to the request of the web client 100, and if the web page required by the web client 100 is not stored in the store 240, sends the HTTP request to the corresponding web server 400.

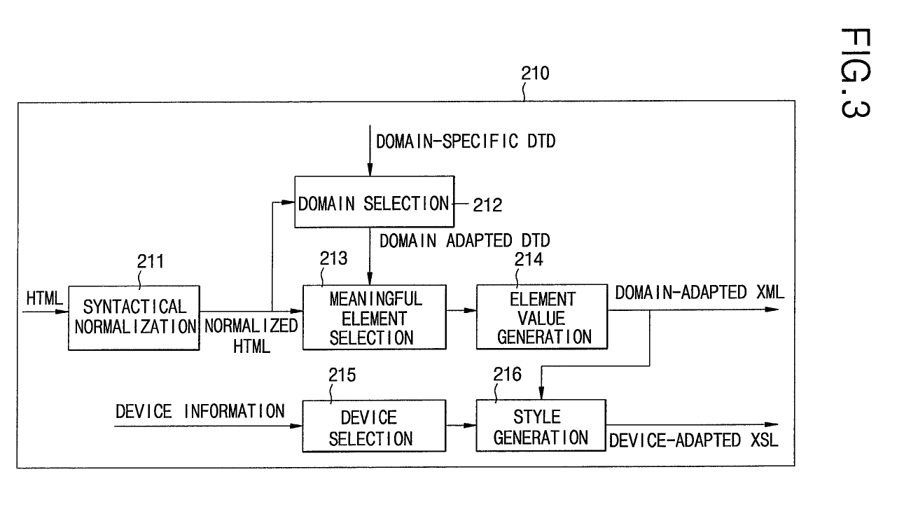

FIG. 3 is a diagram illustrating the construction of the HTML-XML reconstruction 210 in FIG. 2.

The HTML-XML reconstruction 210 comprises a syntactical normalization 211, a domain selection 212, a meaningful element selection 213, an element value generation 214, a device selection 215, and a style generation 216.

The syntactical normalization 211 normalizes the HTML document received from the HTTP 250 to generate a normalized HTML. Such the normalized HTML is used at selecting the domain and selecting the meaningful element.

The domain selection 212 receives the HTML document normalized by the syntactical normalization 211, and extracts domain-specific DTDs with reference to the previously stored domain-specific DTD database.

The meaningful element selection 213 selects the meaningful element by receiving the domain-adapted DTD generated by the domain selection 212 and the normalized HTML document from the syntactical normalization 211.

The element value generation 214 generates the element value by inputting the meaningful element selected by the meaningful element selection 213, and generates the domain-adapted XML.

The device selection 215 receives the device information of the web client 100 from the web client 100 to select the device adapted to the device information. The device information provided from the web client 100 comprises processor performance, memory capacity, displaying resolution or the like. The device selection is performed to transform the web page adapted to the device performance of the web client 100.

The style generation 216 performs the style generation by use of the domain-adapted XML document produced from the element value generation 214 to generate the device-adapted XSL document, if the device selection 215 selects the device according to the device information.

The HTML document stored in the cache 240 of the FIG. 2 is transformed to the normalized HTML document through the syntactical normalization 211. The normalized HTML document is firstly used in the domain selection 212, and the domain selection 212 extracts the domain-adapted DTD by use of the HTML document normalized by the domain-specific DTD database. The normalized HTML is used in the meaningful element selection 213. The domain-adapted XML document is generated from the normalized HTML document by adapting the domain-adapted DTD. At that time, after the selection of the meaningful element of the meaningful element selection 213, a process of generating the element value is required by the element value generation 214.

The process of generating the domain-adapted XML document and device-adapted XSL document will now be explained.

If a request for the web page is provided by the web client 100 of FIG. 2, according to the transmission of the device information of the corresponding client, the device selection is performed by the device selection 215. The device information provided from the web client 100 comprises processor performance, memory capacity, displaying resolution or the like.

If the device is selected by the device selection 215 based on the device information, the style generation 216 performs the style generation to generate the device-adapted XSL by use of the previously generated domain-adapted XML document.

Through the whole procedure explained with reference to FIG. 3, the domain-adapted XML document and the device-adapted XSL document are generated, and are stored in the cache 240 of FIG. 2. The image reformat 220 performs the function of transforming the image adapted to the web client 100 by use of the device-adapted XSL document.

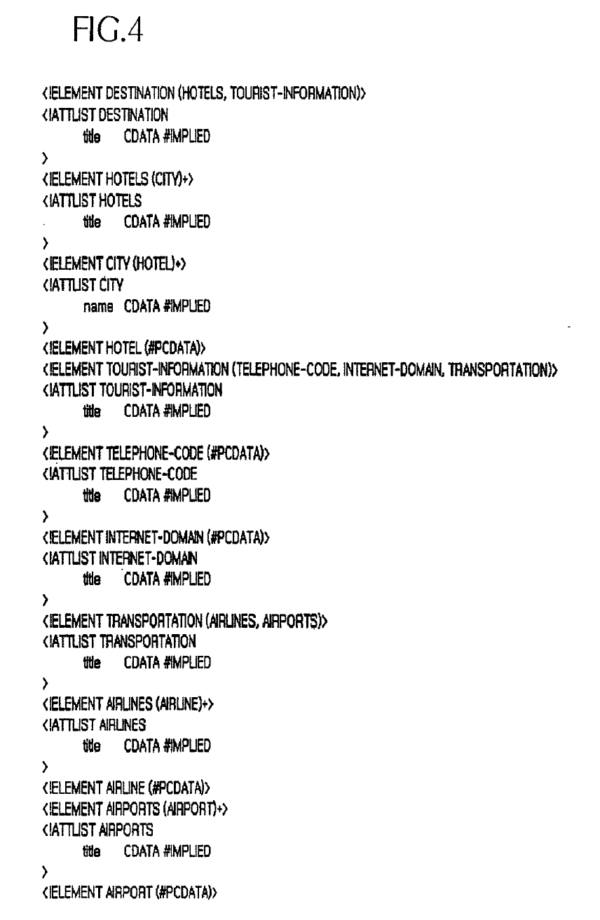

FIG. 4 shows one embodiment of the domain-adapted DTD selected from the domain-specific DTD database by the domain selection 212 of FIG. 3.

The domain represented by the DTD of FIG. 4 is a tour destination comprising hotels, cities, airlines as an element.

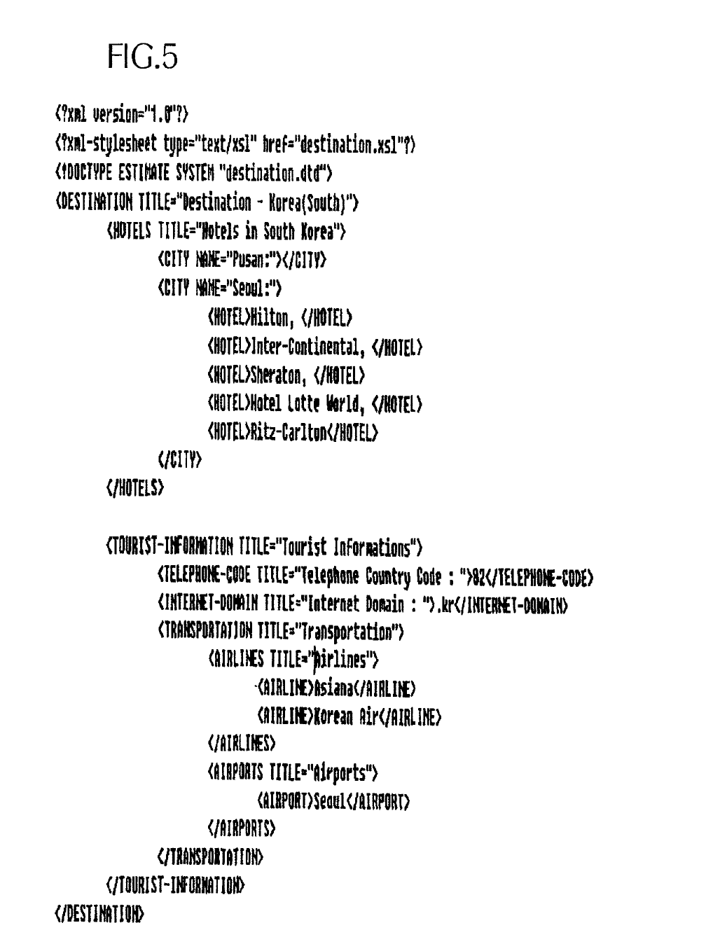

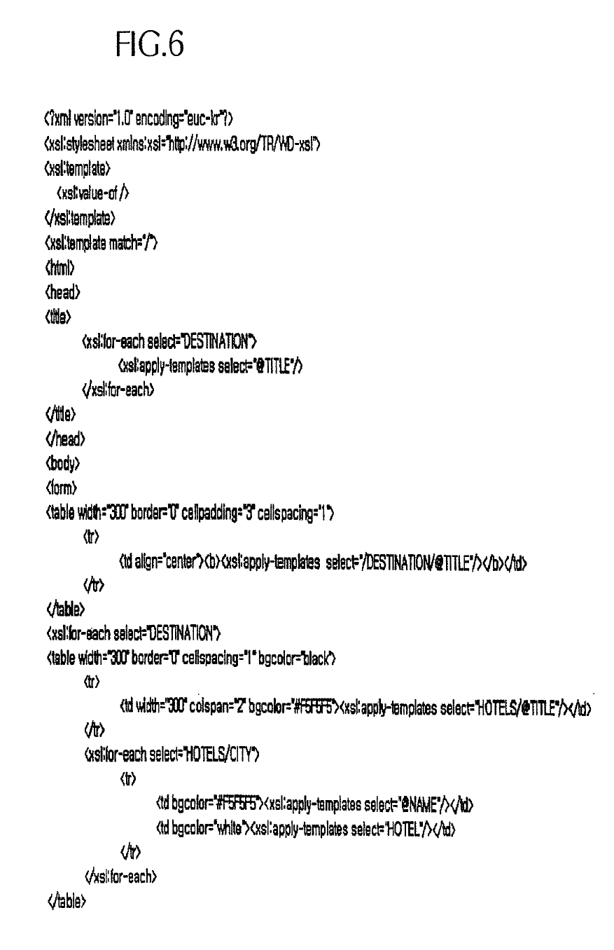

FIGS. 5 and 6 show the domain-adapted XML document and the device-adapted XSL document each generated by use of the tour destination DTD of FIG. 4.

The domain-adapted XML document of FIG. 5 is composed of XML elements from the tour destination DTDs of FIG. 4, and is made by deducing each attribute value of XML elements from the normalized HTML document of FIG. 3.

The device-adapted XSL document of FIG. 6 is made by the previously generated tour destination XML of FIG. 5 and the device information of the corresponding client. FIG. 6 shows one example of the XSL document adapted to the non-PC information having a display of 320*240 resolution.

By employing the system for providing the web page of the XML-based according to present invention, the existing web pages for the PC which are constructed in bulk are automatically transformed, without manually reconstructing in everything.

By providing a typical caching function and an XML-based web page transforming function to the proxy server, the web page transformation is executed simultaneous with the web server connection, so that a great amount of the existing web pages may be automatically transformed and reused for the purpose of adapting to the domain search and information terminals.

In case of non-PC information terminals such as web-TV, PDA, web phone or the like having limits of processing speed, telecommunication speed, display resolution relative to the desktop computer, it is overcame by employing the system of providing the XML-based web page according to the present invention, thereby displaying the downsized web pages adapted to the information terminal environments.

Meanwhile, the method of transforming the XML-based web page according to the present invention may be employed to display identical XMLs by use of several XSLs, thereby effectively supporting various kinds of non-PC information terminals.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A system of providing an XML-based web page of a proxy server providing a home page of a web server for a web client of a non-PC information terminal, the system comprising:
an HTML-XML reconstruction for transforming an HTML document transmitted from the web server to generate XML and XSL documents in a pattern of data adapted to the web client of the non-PC information terminal;
an image reformat for reformatting an image in the web page in a pattern of data adapted to the web client of the non-PC information terminal corresponding to the XML and XSL documents generated by the HTML-XML reconstruction;
a pre-fetch for pre-fetching the web page received from the web server according to a probability condition based on a reference history of the web client;
a store for storing the pre-fetched web page, and the XML and XSL documents; and
an HTTP for connecting to the web client of the non-PC information terminal and the web server by use of an HTTP protocol to transfer the web page transmitted from the web server to the HTML-XML reconstruction, and providing the information stored in the store to the web client of the non-PC information terminal.

2. The system as claimed in claim 1, wherein the HTML-XML reconstruction comprises:
a syntactical normalization for normalizing the HTML document received from the HTTP to generate a normalized HTML;
a domain selection for receiving the HTML document normalized by the syntactical normalization, and extracting a domain-specific DTD with reference to a previously stored domain-specific DTD database;
a meaningful element selection for selecting a meaningful element by receiving a domain-adapted DTD generated by the domain selection and the normalized HTML document from the syntactical normalization to generate a domain-adapted XML;
an element value generation for generating an element value by inputting the meaningful element selected by the meaningful element selection, and generating the domain-adapted XML;
a device selection for receiving a device information of the web client from the web client to select the device adapted to the device information; and
a style generation for performing a style generation by use of the domain-adapted XML document produced from the element value generation to generate the device-adapted XSL document, if the device selection selects the device according to the device information.

3. The system as claimed in claim 2, wherein the device information comprises at least one of processor performance, memory capacity, and display resolution.

4. A method of providing an XML-based web page of a proxy server providing a home page of a web server for a web client of a non-PC information terminal, the method comprising the steps of:
transforming an HTML document transmitted from the web server to generate an XML document adapted to a domain containing a content of the web page and an XSL document adapted to a device of the web client;
reformatting an image in the web page in a pattern of data adapted to the web client of the non-PC information terminal corresponding to the XML and XSL documents generated;
pre-fetching for the web page received from the web server according to a probability condition based on a reference history of the web client, and temporarily storing the pre-fetched web page; and
upon receiving a request of the web client of the non-PC information terminal, providing the XML and XSL documents, the image, and the web page to the web client of the non-PC information terminal.

5. The method as claimed in claim 4, wherein the step of generating the XML and XSL documents comprises the steps of:
normalizing the HTML document received from the web server to generate the normalized HTML document;
selecting a domain in which the HTML document is contained, with reference to a previously stored domain information regarding to the normalized HTML document;
receiving the domain selecting information and the normalized HTML document, and selecting a meaningful element for generating an XML adapted to a corresponding domain;
generating an element value by inputting the selected meaningful element to generate the XML adapted to a corresponding domain; and
receiving a device information transferred from the web client, performing a style generation using the XML document adapted to the corresponding domain to generate an XML document adapted to a corresponding device.

6. A storage medium for executing a method of providing an XML-based web page of a proxy server providing a home page of a web server for a web client of a non-PC information terminal, the storage medium capable of being read by a digital processor, and storing a program of commands executed by the digital processor, the program being implemented by types, with the program comprising the steps of:
transforming an HTML document transmitted from the web server to generate an XML document adapted to a domain containing a content of the web page and an XSL document adapted to a device of the web client;
reformatting an image in the web page in a pattern of data adapted to the web client of the non-PC information terminal corresponding to the XML and XSL documents generated;
pre-fetching for the web page received from the web server according to a probability condition based on a reference history of the web client, and temporarily storing the pre-fetched web page; and
upon receiving a request of the web client of the non-PC information terminal, providing the XML and XSL documents, the image, and the web page to the web client of the non-PC information terminal.
